(19) United States
(12) Patent Application Publication
(10) Pub. No.: US 2026/0336535 A1
(43) Pub. Date: Oct. 29, 2026

(54) TRIM PANEL FOR A MOTOR VEHICLE COMPRISING A LIGHT TRANSMISSION ZONE MADE FROM THERMOSETTING POLYURETHANE

(71) Applicant: OPmobility SE, Lyon (FR)

(72) Inventors: Pascal BANRY, Sainte-Julie (FR); Damien Boisson, Sainte-Julie (FR)

(21) Appl. No.: 19/658,846

(22) Filed: Apr. 27, 2026

(30) Foreign Application Priority Data
Apr. 28, 2025 (FR) 2504485

(51) Int. Cl. B60R 13/04; B60Q 1/26

(52) U.S. Cl. CPC B60R 13/04; B60Q 1/2696

(57) ABSTRACT

A trim panel for a motor vehicle including at least one light transmission zone, made of a first plastic material suitable for light transmission, and at least one masking zone adjacent to the light transmission zone and made at least in part of a second plastic material having a light transmittance lower than a light transmittance of the first plastic material. The first plastic material is a transparent or translucent polyurethane.

### TECHNICAL FIELD

The invention relates to a trim panel for a motor vehicle, as well as a trim module, a motor vehicle front face or a motor vehicle comprising such a trim panel. The invention also relates to a method for manufacturing such a trim panel.

### BACKGROUND

A motor vehicle comprising a front face comprising in particular a trim module that can integrate technical features, such as sensors or signaling members, and aesthetic features, such as decorations or members for diffusing light patterns is already known from the prior art. Such a trim module has a high added value and is expensive to manufacture and relatively heavy.

The trim panel typically comprises at least one light transmission zone, made of a first material capable of transmitting light, and at least one masking zone adjacent to the light transmission zone, the masking zone being generally opaque to visible light or semi-transparent. The light transmission zone allows light to pass from the inside of the trim module to the outside, for example, to transmit a light signal, illuminate the road, or display decorative elements. The masking zone can be used to conceal technical elements such as sensors, fastening interfaces or sealing elements, in order to improve the aesthetic appearance of the vehicle. Traditionally, the trim panel is formed by at least one part made by molding of a first transparent material, for example polycarbonate transparent to visible light, and at least one other part, made of a second, opaque material, for example opaque polycarbonate, overmolded onto the first part in the area of at least one zone of the trim panel that is to be made opaque.

Such parts yield satisfactory results. However, there is an ongoing effort to provide a trim panel that is simpler and more economical to manufacture, while being as lightweight as possible.

### SUMMARY OF THE INVENTION

One aim of the invention is to provide a motor vehicle trim panel that is lightweight and simple and economical to manufacture.

To this end, the invention relates to a trim panel for a motor vehicle, comprising:
at least one light transmission zone, made of a first plastic material suitable for light transmission,
at least one masking zone adjacent to the light transmission zone and made at least in part of a second plastic material having a light transmittance lower than a light transmittance of the first plastic material,

characterized in that the first plastic material is a transparent or translucent polyurethane.

The use of a transparent or translucent polyurethane as the first plastic material is particularly advantageous. First of all, unlike other transparent or translucent plastic materials, such as transparent or translucent polycarbonate, polyurethane does not require a protective varnish coating on its outer surface to protect it from mechanical, chemical or physical attack. This means that it is possible to use only the first plastic material in the light transmission zone, and no additional materials such as protective varnish. This makes it possible to limit the thickness of the trim panel in the light transmission zone, thereby reducing the weight of the trim panel and simplifying its manufacture. In addition, polyurethane has self-healing properties, allowing it to repair itself spontaneously following a small impact or scratch, such as that caused by a spray of gravel.

The light transmission zone allows at least some of the light passing through it to be transmitted. Depending on the embodiments, it may be transparent or translucent. An element is considered transparent when it allows light to pass through it, preferably in the visible, infrared or ultraviolet range. In the case of visible light, a transparent element allows objects to be clearly distinguished through its thickness. An element is considered transparent when its transmittance is greater than or equal to 85%. In the case of visible light, an element is considered translucent when it allows light to pass through it in the visible range, but without allowing objects to be clearly distinguished. A translucent element is then one through which vision is blurred. An element with a transmittance greater than or equal to around 50% and less than 85% is considered translucent. The transmittance or light transmission of a material is the fraction of luminous flux passing through it. Transmittance represents the ratio of light intensity transmitted by the material to the incident light intensity.

The masking zone can be used to conceal, from the outside, technical elements such as sensors, fastening interfaces or sealing elements, in order to improve the aesthetic appearance of the vehicle. In some embodiments, the masking zone can be opaque, semi-transparent or translucent. An element is opaque when it does not let light through, for example visible light. An element is semi-transparent when it allows the transmission of light in the visible range emitted by a visible light source with possible partial light absorption, but prevents the transmission of natural visible light. In this way, a semi-transparent masking zone enables elements arranged behind it to be concealed from the outside, while at the same time allowing part of the light emitted by a light source concealed behind the masking zone to be transmitted to the outside. In the embodiment where the masking zone is translucent, it is intended that the transmittance of the masking zone remains lower than the transmittance of the light transmission zone.

The invention may comprise one or more of the following optional features, taken alone or in combination.

The first plastic material is a transparent or translucent thermosetting polyurethane. The use of transparent or translucent thermosetting polyurethane makes it easier to manufacture the trim panel compared to other materials, such as transparent or translucent polycarbonate. In particular, thermosetting polyurethane can be molded at much lower pressures and temperatures than those used for molding other materials, such as transparent or translucent polycarbonate. In this way, energy costs, and therefore economic costs, are reduced. Using lower molding pressures also allows the use of smaller, less expensive presses. Furthermore, the fact that polyurethane is thermosetting and not thermoplastic means that, all other things being equal, the light transmission zone obtained is more transparent, has better resistance to ultraviolet radiation and better rigidity, which improves the structural strength of the trim panel.

The second plastic material is a thermoplastic material that is opaque to light, semi-transparent or translucent. According to the embodiments, for example, the second plastic material may be a thermoplastic material that is opaque to visible light, ultraviolet radiation or infrared radiation. It is understood that when the second plastic material is semi-transparent or translucent, this semi-transparency or translucency relates to visible light as indicated in the definition of these terms set out hereinbefore.

According to one embodiment, at least one insert is overmolded at least in part by the first plastic material. The use of thermosetting polyurethane as the first plastic material advantageously makes it easy to integrate different types of inserts by overmolding. In particular, thermosetting polyurethane, unlike thermoplastic polyurethane for example, is molded at low pressure and low temperature. In this way, insert overmolding with the first plastic material can be carried out without risking damage to the insert. It is also noted that this results in a more economical manufacturing method, as the temperatures and pressures used are lower, power consumption

Preferably, the insert is chosen from a luminous film, for example an OLED film, a decorative film, a heating film, an electronic film, an emblem and a sensor. This makes it easy to add various additional functions to the trim panel. A luminous film has, for example, a decorative and/or lighting function. A heating film has, for example, a defrosting function for at least part of the trim panel. This function is particularly useful, for example, to ensure satisfactory light transmission for the light transmission zone. The electronic film is, for example, a capacitive film. In addition, various sensors can be integrated into the first plastic material so as to provide various detection functions.

Preferably, the thickness of the trim panel in the light transmission zone is between 1.5 and 3.5 mm, preferably between 1.5 and 2.5 mm. The use of polyurethane provides a particularly thin light transmission zone. In particular, the use of polyurethane eliminates the need for a protective varnish, adding mass and thickness to the trim panel.

The invention also relates to a trim module for a motor vehicle, comprising a trim panel as described above.

The invention further relates to a motor vehicle bodywork part comprising a trim panel as described above. According to the embodiments, the bodywork part is, for example, a motor vehicle front face, a motor vehicle tailgate, a motor vehicle side door or a motor vehicle fender.

The invention also relates to a motor vehicle comprising a trim panel as previously described.

Finally, the invention relates to a method for manufacturing a trim panel for a motor vehicle, the trim panel being as described above, wherein:
a) a first part of the trim panel, intended to form at least one masking zone of the trim panel, is molded with a plastic material, referred to as the second plastic material,
b) the first part of the trim panel is overmolded with a transparent or translucent polyurethane, referred to as the first plastic material, the second plastic material having a light transmittance lower than a light transmittance of the first plastic material, thus forming at least one light transmission zone of the trim panel.

According to a preferred embodiment, the first plastic material is a transparent or translucent thermosetting polyurethane.

Preferably, the overmolding step is carried out at a pressure of between 20 and 100 bar. Such pressure values are sufficient for the molding of thermosetting polyurethane, while being low enough to reduce the energy cost of the manufacturing method and allow the incorporation of inserts into the first plastic material.

Preferably, the overmolding step is carried out at a temperature of between 80 and 120° C. Such temperature values are sufficient for the molding of thermosetting polyurethane, while being low enough to reduce the energy cost of the manufacturing method and allow the incorporation of inserts into the first plastic material.

### BRIEF DESCRIPTION OF THE FIGURES

The invention will be better understood upon reading the following description, which is provided merely by way of non-limiting example and with reference to the appended drawings, in which:

FIG. 1 is a schematic perspective representation of a front part of a motor vehicle comprising a trim module comprising a trim panel according to one embodiment of the invention;

FIG. 2 is a schematic perspective representation of the trim panel shown in FIG. 1.

### DETAILED DESCRIPTION

In the detailed description, the longitudinal direction (or X-axis), the transverse direction (or Y-axis) and the vertical direction (or Z-axis) refer to the directions of a motor vehicle and are shown the figures.

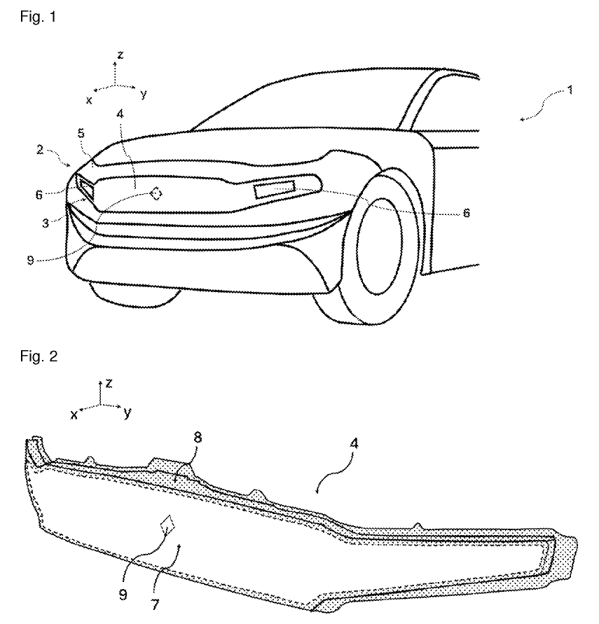

FIG. 1 shows the front part of a motor vehicle 1 that comprises a front face 2 comprising a trim module 3 that comprises a trim panel 4. According to the invention, “front face” is understood to mean the part or parts of the motor vehicle 1 delimiting an external surface visible from outside in front of the motor vehicle 1.

The front face 2 comprises at least one main panel 5 made of plastic material. This main panel 5 has a hole in which the trim module 3 and the optical units 6 are mounted (FIG. 1). In the present case, the two optical units 6 are integrated into the trim module 3 and are arranged respectively at two opposite lateral ends of the trim module 3. This integration of the optical units 6 into the trim module 3 facilitates the mounting of the front face 2 on the motor vehicle 1 and improves the aesthetics of the vehicle 1 by making it possible, for example, to obtain a continuity of shape, and an absence of interface play, between the trim module 3 and the optical units 6.

The trim module 3 is arranged such that its external surface is flush with the external surface of the main panel 5. The external surface of the trim module 3 and the external surface of the main panel 5 thus have a continuity of shape in order to create an effect giving the illusion that the front face 2 is a single piece. In general, the trim module 3 is preferably arranged such that its outer surface is flush with any bodywork elements located in the immediate vicinity of the trim module 3. In another embodiment, the trim module 3 is arranged so that its outer surface is not flush with the surface, i.e., its outer surface is recessed with respect to at least part of the outer surface of the bodywork elements located in its immediate vicinity, so as to better protect it in the event of an impact.

According to the described embodiment, the trim module 3 has a general elongated shape extending over more than 50% of the width of the front face 2. More particularly, in the present case, the trim module 3 extends over about 90% of the width – i.e., the dimension along the transverse axis Y − of the front face 2. Of course, according to alternative embodiments, the trim module can extend across less than 50% or more than 90% of the front face 2. The trim module 3 is intended to be attached to a support structure of the motor vehicle 1, for example on the body of the motor vehicle 1 or on a front technical face of the vehicle 1. As shown in FIG. 1, the trim panel 4 is similar in shape and dimensions to the trim module 3.

The trim module 3 comprises an electromagnetic wave diffusion member. In the present case, this electromagnetic wave diffusion member is able to emit electromagnetic waves in the visible spectrum, commonly called visible light hereinafter. This diffusion member comprises for example a light guide coupled to a light emitter (not shown). According to other embodiments, the electromagnetic wave diffusion member is able to emit other types of electromagnetic waves, for example infrared waves or ultraviolet radiation. Provision may be made for the trim module 3 to comprise multiple electromagnetic wave diffusion members, each member being able to diffuse one or more types of electromagnetic waves.

The trim panel 4 of the trim module 3 forms the outer surface of the trim module 3 visible from the outside. Together with a main body (not shown) of the trim module 3, the trim panel 4 forms a housing containing the various technical components of the trim module 3, such as an electromagnetic wave diffusion member, a light guide or a sensor.

The trim panel 4 comprises at least one light transmission zone, made of a first plastic material suitable for light transmission. According to the present embodiment, this first plastic material is a thermosetting polyurethane. According to this first embodiment, the trim panel 4 comprises a single light transmission zone 7. According to other embodiments, the trim panel 4 may comprise a greater number of light transmission zones 7, for example between two and twenty, preferably between two and ten. In this case, the light transmission zone 7 occupies a larger part of the outer surface of the trim panel 4 and therefore of the trim module 3. The light transmission zone 7 allows in particular visible light to pass from the inside of the trim module 3 to the outside, for example, to transmit a light signal, illuminate the road, or display decorative elements. In particular, in the case where the trim module 3 comprises optical units 6, the light transmission zone 7 allows visible light emitted by these optical units 6 to pass through. The thermosetting polyurethane has the advantage of being particularly transparent, and therefore of allowing high light intensity illumination.

In the present case, the thickness of the trim panel 4 in the light transmission zone 7 is preferably between 1.5 and 2.5 mm. Such a thin thickness is made possible by the use of thermosetting polyurethane as the first material, as such a material is particularly resistant and does not require the application of an additional protective layer, such as a varnish layer. Reducing the thickness of the trim panel 4 reduces its size and weight, which is particularly advantageous.

The trim panel 4 further comprises at least one masking zone 8 adjacent to the light transmission zone and made at least in part of a second plastic material. The second plastic material has a light transmittance lower than a light transmittance of the first plastic material. In particular, in this case, the masking zone 8 is opaque to visible light. According to an alternative embodiment, the masking zone 8 can be semi-transparent or translucent, provided that the second material has a light transmittance lower than a light transmittance of the first plastic material. In this case, the second plastic material is an opaque thermoplastic material such as, for example, polycarbonate, thermoplastic polyurethane or polypropylene. In particular, the masking zone 8 can be used to conceal technical elements, such as fastening interfaces, technical walls, sensors or sealing elements, in order to improve the aesthetic appearance of the vehicle. In this case, the trim panel 4 comprises a single masking zone 8 which extends around the entire periphery of the trim panel 4. According to other embodiments, the trim panel 4 may comprise a greater number of masking zones 8, for example between two and twenty, preferably between two and ten. Furthermore, according to other embodiments, the masking zone 8 does not necessarily extend over all or part of the periphery of the trim panel 4.

As shown in FIG. 2, the trim panel 4 comprises an insert 9 overmolded at least in part by the first plastic material of the trim panel 4. According to the present embodiment, the insert 9 is a heating film with a defrosting function. Such a heating film can, for example, improve the measurement reliability of certain sensors when placed opposite such a sensor. According to other embodiments, the insert 9 may be of another type, for example a luminous film, such as an OLED film, a decorative film or an electronic film, such as a capacitive film, or an emblem. Depending on the embodiment, the trim panel 4 may comprise a plurality of different inserts 9.

The following describes a manufacturing method for the trim panel 4 described above. This method comprises the following steps:
a) A first part of the trim panel 4, intended to form the masking zone 8 of the trim panel 4, is molded with the second plastic material, for example opaque polycarbonate.
b) The first part of the trim panel produced in the previous step is overmolded with a transparent or translucent thermosetting polyurethane, referred to as the first plastic material. As previously mentioned, the second plastic material has a light transmittance lower than the light transmittance of the first plastic material, thus forming the light transmission zone 7 of the trim panel 4. According to the present embodiment, prior to injection of the thermosetting polyurethane, the insert 9, which in this case is formed by a heating film, is placed in the mold, so that the thermosetting polyurethane overmolds this insert 9 and thus integrates it into the trim panel. Overmolding of the insert 9 is made possible by the low pressures and temperatures used during overmolding of the thermosetting polyurethane. In particular, according to the present embodiment, the overmolding step is carried out at a pressure of between 20 and 100 bar and at a temperature of between 80 and 120° C, which prevents the risk of damaging the insert 9 during overmolding.

The invention is not limited to the embodiments presented, and other embodiments will become clearly apparent to a person skilled in the art. Alternatively or additionally, the trim panel 4 according to the invention can in particular be integrated into the motor vehicle 1 in a bodywork part other than the front face 2, for example in a tailgate, side door or fender.

### LIST OF REFERENCES

1: motor vehicle
2: front face
3: trim module
4: trim panel
5: main panel
6: optical units
7: light transmission
8: masking zone
9: insert

1. A trim panel for a motor vehicle, comprising:
at least one light transmission zone, made of a first plastic material suitable for light transmission, and
at least one masking zone adjacent to the light transmission zone and made at least in part of a second plastic material having a light transmittance lower than a light transmittance of the first plastic material,
wherein the first plastic material is a transparent or translucent polyurethane.

2. The trim panel according to claim 1, wherein the first plastic material is a transparent or translucent thermosetting polyurethane.

3. The trim panel according to claim 2, wherein at least one insert is overmolded at least in part by the first plastic material.

4. The trim panel according to claim 3, wherein the insert is chosen from a luminous film, a decorative film, an emblem, a heating film, an electronic film and a sensor.

5. The trim panel according to claim 3, wherein the insert is an OLED film.

6. The trim panel according to claim 1, wherein the second plastic material is a thermoplastic material that is opaque to light, semi-transparent or translucent.

7. The trim panel according to claim 1, wherein a thickness of the trim panel in the light transmission zone is between 1.5 and 3.5 mm.

8. The trim panel according to claim 1, wherein a thickness of the trim panel in the light transmission zone is between 1.5 and 2.5 mm.

9. A trim module for a motor vehicle, comprising the trim panel according to claim 1.

10. A bodywork part of a motor vehicle, comprising the trim panel according to claim 1.

11. A motor vehicle, comprising the trim panel according to claim 1.

12. A method for manufacturing a trim panel for a motor vehicle, the trim panel being according to claim 1, wherein:
a) a first part of the trim panel, intended to form at least one masking zone of the trim panel, is molded with the second plastic material, and
b) the first part of the trim panel is overmolded with the first plastic material, being the transparent or translucent polyurethane, the second plastic material having a light transmittance lower than a light transmittance of the first plastic material, thus forming at least one light transmission zone of the trim panel.

13. The method according to claim 12, wherein the first plastic material is a transparent or translucent thermosetting polyurethane.

14. The method according to claim 13, wherein the overmolding step is carried out at a pressure of between 20 and 100 bar.

15. The method according to claim 13, wherein the overmolding step is carried out at a temperature of between 80 and 120° C.
